(19) United States
(12) Patent Application Publication
(10) Pub. No.: US 2023/0058546 A1
(43) Pub. Date: Feb. 23, 2023

(54) Wearable Insect Capture Device

(71) Applicant: Jane Ellen Gower, Dresden, ME (US)

(72) Inventor: Jane Ellen Gower, Dresden, ME (US)

(21) Appl. No.: 17/845,026

(22) Filed: Jun. 21, 2022

Related U.S. Application Data
(60) Provisional application No. 63/260,335, filed on Aug. 17, 2021.

(51) Int. Cl. A01M 1/14

(52) U.S. Cl. CPC A01M 1/14; A01M 2200/011

(57) ABSTRACT

A wearable insect capture device that may be removably attached to a user, for example on a lower portion of the user's leg, to capture insects that may attempt to climb up the user.

### BACKGROUND INFORMATION

### Field of the Invention

The invention relates to devices that capture insects, and in particular wearable devices that capture insects such as ticks.

### Discussion of Prior Art

Insects, and ticks in particular, have become an increasing problem. With ticks, tick-borne diseases have become a significant concern as the tick population has exploded. The acts of hiking, taking outdoor walks, or simply enjoying ones backyard have essentially become dangerous activities due to the increased likelihood of being bitten by ticks and acquiring one of the aforementioned tick-borne diseases.

Conventional methods of tick prevention commonly involve the application of insecticides, such as permethrin and/or diethyltoluamide (“DEET”). These types of products, however, are often harmful to the people wearing/using them, and/or harmful to pets or small children, and/or harmful to the user's clothing.

What is needed, therefore, is a safe, convenient, and effective manner of capturing ticks before they are able to bite.

### BRIEF SUMMARY OF THE INVENTION

The invention is a wearable insect capturing device that is removably attachable to a user such as a person, pet, or animal. More specifically, the device is removably wrapable around the user's lower leg, often around or just above the ankle, and contains an adhesive on an outer surface. In use, the user may attach a single device to a lower portion of each leg and then go about their normal outdoor activity, such as hiking, taking walks, or playing in a backyard, and as insects such as ticks attempt to climb up a user's leg they become stuck in the adhesive and eventually die. Once the user has completed the desired activity, the device may be unwrapped and removed and then either stowed for future use or discarded.

The device may be removeably secured in place using a number of conventional fasteners, such as, for example, hook and loop fasteners. A number of adhesives are suitable, such as weather resistant double-sided tapes. A cover layer that may be removably placed on the adhesive without significantly impacting the adhesiveness may also be provided so that the device does not capture unintended items when it is not in use.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of the device according to the invention attached to a user and in use.

FIG. 2 is a perspective view of the device showing the device attached to a user and with a cover on top of the capture layer.

FIG. 3 is a top plan view of the device showing an outer surface.

FIG. 4 is a bottom plan view of the device showing an inner surface.

FIG. 5 is a side perspective view of the device in a closed configuration.

FIG. 6 is a top perspective view of the device in a closed configuration.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

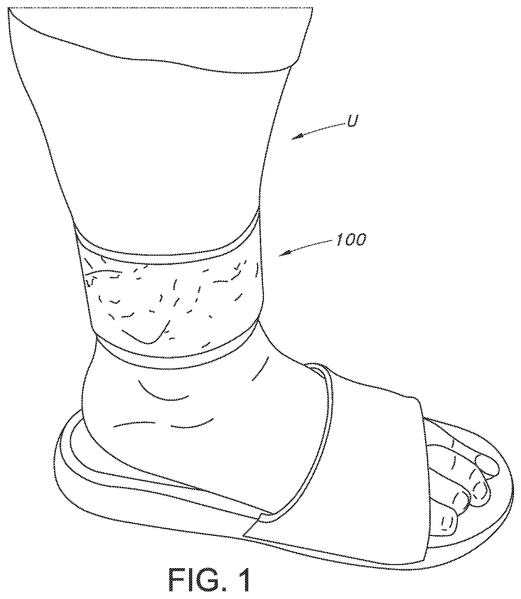

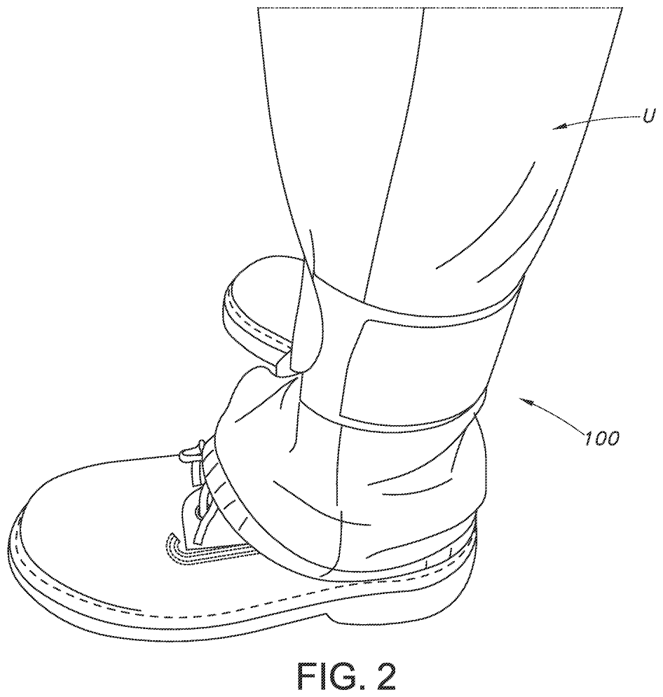

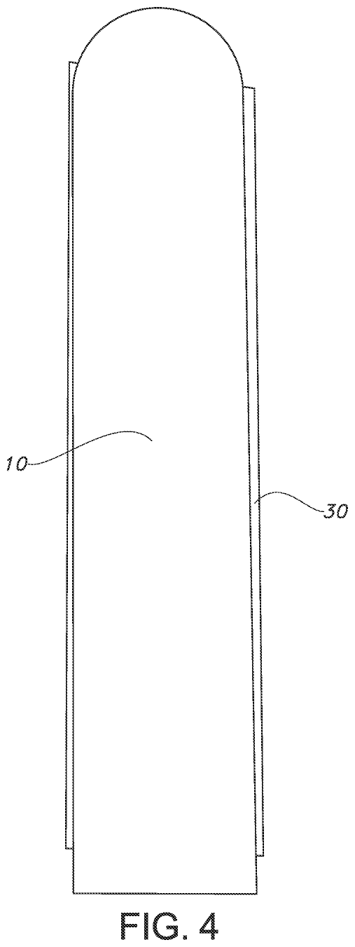

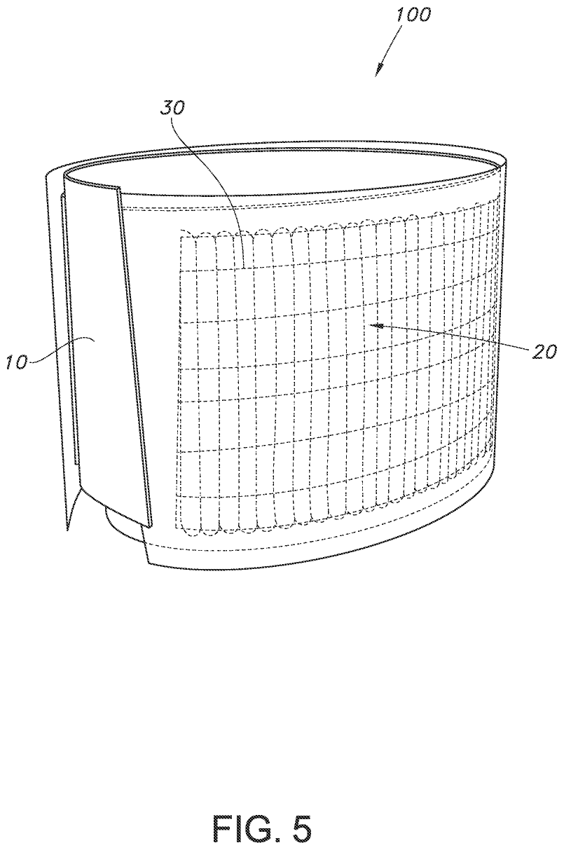

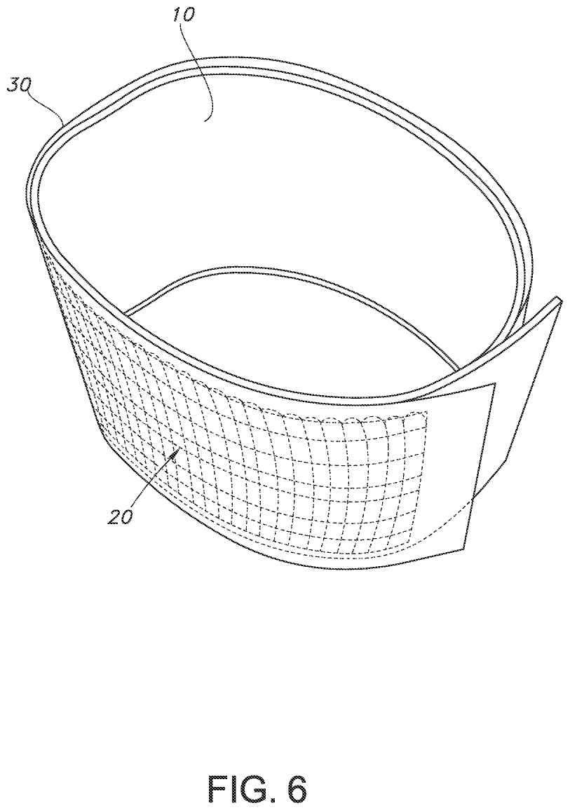

FIGS. 1-6 illustrate a wearable insect capture device 100 according to the invention. The device 100 is shown in use in FIGS. 1 and 2, wrapped around a user's U lower leg slightly above the ankle. An outer side of the device 100 is configured to capture any bugs that may attempt to climb the user's U leg, thus preventing bites.

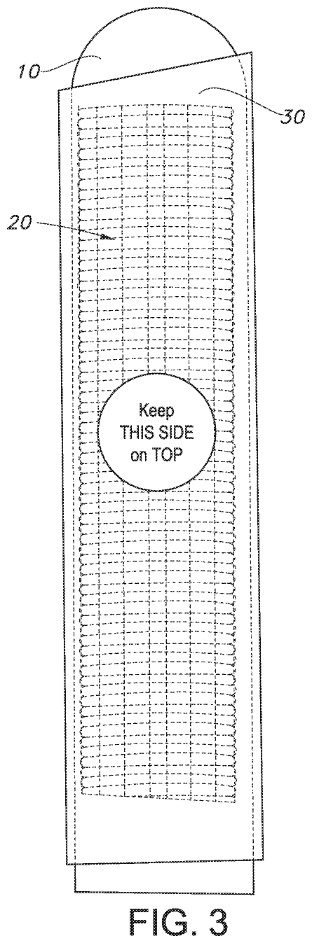

The device 100 includes an base layer 10 that is made of a durable, odor free, non-allergenic material, such as a low density polyethylene or a combination of polypropylene with polyester, with hook and loop fasteners. For example, there are a number of suitable Velcro straps that may serve as a suitable base layer 10. The base layer 10 is largely rectangular in shape, likely having one end that is rounded or curved, for example as shown in FIG. 3, so as to create a better hold with the hook and loop fasteners. More specifically, the hook and loop straps having a radius on one end of the strip and square corners on the other helps the wearer conveniently orient the strip in the desired position and helps to minimize any pulling, tearing, or catching on the user's clothing/footwear or any vegetation during motion or at rest. The base layer 10 in this configuration is easily bendable to wrap around users' legs of varying widths, its inner surface is comprised of a soft and comfortable fabric to fit comfortably against the user's leg.

The device 100 includes a capture layer 20 that is attached to an exterior side of the base layer 10. The capture layer 20 is, or includes, an adhesive that captures insects as they attempt to pass over the device 100 in order to climb a user's leg. For example, the capture layer 20 may be a double-sided tape that is particularly durable. Double-sided carpet tapes are particularly well suited for this application given that they retain their adhesive properties when exposed to rain and the types of general wetness that users' might experience while walking in the woods or hiking on a trail. As one non-limiting example, Roberts brand double-sided indoor/outdoor carpet tape is a suitable capture layer 20.

To construct the device 100 when the capture layer 20 is a double-sided tape, one side of the capture layer 20 is adhesively applied to the base layer 10, the capture layer having a similar shape as the base layer but with slightly smaller dimensions so as to allow for an area where the hook and loop fasteners may connect and secure the device 100 to the user. Other types of adhesives may also be used as the capture layer 20.

When the device 100 is not in use a cover layer 30 may be applied to the capture layer 20 in order to protect the adhesive and prevent the adhesive from adhering to unintended objects. For example, a strip of embossed polystyrene plastic or polycarbonate plastic that is slightly larger than the capture layer 20 is appropriate. The cover layer 30 may be applied once the device 100 is originally assembled so as to protect the adhesive as the device 100 is shipped, sold, and any time prior to use. To use the device 100, the user simply peels the cover layer off 30 of the capture layer 20 to expose the adhesive.

The size and shape of the device may vary along with the intended type of user and preferred location of attachment on the user. In general, it is preferable if the device is configured to attach to the user at a location just above the user's ankle bone. In one preferred embodiment that is constructed for the average human, the base layer measures approximately 13 inches in length and 3 inches in width. Larger or smaller devices may be made for, for example, pets and animals such as dogs or horses. The device may also be configured to attach to other extremities, for example, a horse's tail. In all instances, the capture layer 20 is nearly the same size as the base layer, leaving an amount of space on either end for the fasteners as previously noted.

It is understood that the embodiments described herein are merely illustrative of the present invention. Variations in the construction of the wearable insect capture device may be contemplated by one skilled in the art without limiting the intended scope of the invention herein disclosed and as defined by the following claims.

What is claimed is:

1. A wearable device adapted to capture insects as the insects attempt to crawl up a user, the wearable device comprising:
a base layer having inner side and an outer side and that is configured to wrap around and secure to the user with the inner side placed against the user;
a capture layer that is affixed to the outer side of the base layer and that is configured to capture insects.

2. The wearable device of claim 1, the capture layer including an adhesive.

3. The wearable device of claim 2, the capture layer configured as a double-sided tape.

4. The wearable device of claim 3, the base layer configured to secure to the user with hook and loop fasteners.

5. The wearable device of claim 1, further including a removable cover layer that is removably connected to the capture layer.

6. The wearable device of claim 5, the removable cover layer comprised of a plastic.
